(19) United States
(12) Patent Application Publication
(10) Pub. No.: US 2002/0195594 A1
(43) Pub. Date: Dec. 26, 2002

(54) Spring-loaded winch adaptation for load restraint system

(76) Inventor: Denis G. Cauchon, Alban (CA)

Correspondence Address: D.W. EGGINS, 18 DOWNSVIEW DRIVE, BARRIE, ON, L4M 4P8, CA

(21) Appl. No.: 10/225,357

(22) Filed: Aug. 22, 2002

Related U.S. Application Data
(63) Continuation-in-part of application No. 09/690,718, filed on Oct. 18, 2000.

(51) Int. Cl. B66F 3/00

(52) U.S. Cl. 254/243

(57) ABSTRACT

Hand operated truck winches used for securing loads to a flat bed are given a powerful tensioning spring which is tensioned independently of the operation of the usual winch mechanism, enabling the hold-down force to be maintained, by providing a sustaining spring torque acting upon the winch to take up a substantial degree of slack that may otherwise occur in the tie down member, so as to sustain tension in the tie down member. Several embodiments enable hold-down tensions to be increased significantly. The device can be a kit, some elements of which may be hooked or pinned onto an existing winch for retro-use or with new OEM winches. An extended winch drum may be included. The tensioning spring may be a coil spring or a flat, “clockwork” type spring.

### CROSS REFERENCE TO RELATED APPLICATIONS

This application is a Continuation-in-Part of application Ser. No. 09/690,718 the specification of which is embodied herein by way of reference.

Statement Regarding Federally Sponsored Research or Development—Not Applicable

Reference to Microfiche Appendix—Not Applicable

### BACKGROUND OF THE INVENTION

1. This invention is directed to a winch powered load restraint system, and in particular to a safety adaptation for retrofitting to load securing winches as used on trucks and the like, for securing loads to flatbeds, to convert them into spring loaded safety winches; and to enable the ready provision of OEM spring-loaded winches.

2. The attachment of loads upon the beds of vehicles, for safe transportation, usually relies upon hold-down members, such as straps, chains and the like that are passed over the load and secured to the sides of the vehicle, and there tensioned.

Tensioning of the hold-down members is usually effected by use of an in-situ, hand-operated winch to which one end of the hold-down member is attached.

The winch has a drum, about which one end of the hold-down member is wound. The drum has a capstan which is rotated by means of a lever or Tommy-bar that is inserted into a selected hole in the drum capstan, and the bar is then cranked angularly downward, to wind the hold-down member onto the drum, and to tension it. Such tommy bars are usually about three feet in length, enabling the application of as much as about six hundred pound feet of torque against the winch, which is converted into an equivalent tensioning of the hold down member.

The winch has a toothed ratchet wheel at one end, against which a ratchet pawl engages, to prevent reversed, overhauling rotation of the drum, which would otherwise result in the loss of the tension that is applied to the hold-down member.

The use of nylon or other straps of suitable plastic may provide a degree of elasticity to the load restraint system. However, despite such elasticity, there is a distressingly frequent loss of tension in the hold-down member, due to settling of the load. This loss in tension frequently results in a significant shifting of the load, often with disastrous, and frequently fatal consequences, more particularly for other road users.

In cases where cables or chains are used as the hold-down member, the maintenance of tension is an even greater problem, due to an absence of elasticity and resilience in the hold-down member. Any settling of the load can lead to instantaneous loss of hold-down tension, which can then lead rapidly to radical shifting of the load. This particularly applies to loads such as logs.

This problem of inadequate security of load attachment is currently leading towards legislation proposing that, in the case of road trucks, for every three hours of travel or 150 miles covered, the vehicle shall be halted and the tension of the load securing hold-down members be physically checked.

There are usually a significant number of load members and their associated winches along the length of a modem, extended transport truck and/or trailer; such further checking involves the expenditure of considerable further time and effort on the part of the driver.

Added to this is the roadside hazard for passing traffic, in the event that there is no proper pull-off, and more particularly for the truck driver, who is especially vulnerable when beside the truck, and preoccupied in pulling down with full force against each of many winches, to check and re-tension the respective hold-down members.

A particularly telling factor is the repetition, winch after winch, and time after time of the gross physical strain imposed upon the driver, particularly to the shoulders and back, the latter being especially vulnerable to injury. Instances of severe frontal injury and even death have occurred, usually due to kick-back or dislocation and forcible discharge by the winch of the of the loading tommy bar.

### BRIEF SUMMARY OF THE INVENTION

The present invention has a number of embodiments, which are applicable to OEM equipment and also provide retro-fit improvements to prior-existing load restraint winch systems, as used for securing an elongated load hold-down member such as a load strap, chain or cable in secured, tensioned relation to the load bed of a truck, trailer, rail wagon, etc. .A number of such winches are spaced along the length of a load.

The winch systems presently in widespread use generally comprise winches having a rotatable drum about which is wound a load restraint member, such as a strap, cable or chain; tommy bar actuated torque-applying capstan means for rotating the drum to wind-on and apply load-securing tension to the (hold-down) restraint member; and ratchet means to prevent over-hauling of the drum by the tensioned hold-down member. The winch drums frequently comprise a slotted cylinder, through which slots a load strap can be threaded. Other winch drums may comprise a squirrel cage comprised of three or more parallel bars, through and about which the load strap or cable is secured and wound.

The retro-fit improvement embodiments for existing winches consist of spring-loaded tensioning means, for external attachment to the prior winch in torque-transfer relation therewith, the spring-loaded tensioning means being attached in releasably secured relation, to the existing winch capstan means, while the original winch ratchet is left undisturbed. The torque load of the spring is transferred directly to the original capstan, or to the drum by way of a supplementary ratchet that forms a part of the kit.

The present invention is particularly characterized by the robustness of the elements and their manner of attachment to the existing winch capstan, which involves no welding to the existing winch, and where, in two kit embodiments, the rotating portions are mounted upon the existing winch capstan by being pinned or hooked in place, with consequent ease and speed of assembly and dissassembly.

Two further embodiments include the provision of a replacement winch drum, being of extended length at the capstan end of the drum such that the spring-loaded tensioning means can be mounted upon the drum extension.

In a first extended drum embodiment, the original ratchet wheel is unchanged, being permanently attached to the drum, and the supplementary ratchet wheel is removably attached to the extended, opposite end of the drum.

In a second extended drum embodiment, the supplementary ratchet wheel is secured to the extended end of the drum, as by welding or a threaded joint, and the “original” ratchet wheel is removably attached, by threading or pinning attachment. This simplifies both the required component parts of the kit, and its assembly.

An important characteristic of the different embodiments is the low cost involved, due to the comparatively simple form of the component parts of the respective kits.

In one embodiment there is provided a strong coil spring having a hook at the outboard end to engage the capstan of an existing winch. The other, in-board end of the spring consists of an extended torque arm fitted with an end cup to receive a tommy bar in inserted, torque transfer relation with the spring, to enable manual tensioning of the spring.

A torque bracket may be provided that bolts on to the adjacent end plate of the winch frame, the bracket having a series of stops against which the extended torque arm of the spring can be engaged, to give a range of torque loads for the spring.

In use, with the torque bracket bolted in place and the spring removed, the winch capstan is used in the normal fashion, to take up any slack in the load securing member, (of strap, chain or cable), and the capstan is loaded in the usual fashion to tension the securing member to the normal extent.

The spring is then placed over the capstan, with its outboard hook portion engaged with one of the bar-holes of the capstan. The tommy bar is then inserted into the in-board end cup of the spring, and the bar moved downwardly to tension the spring, while bringing the extended torque arm of the spring into secured, retained relation behind a selected one of the stops of the torque bracket.

In this way, the winch is initially loaded to its usual tensioned extent, and a significant spring torque is then directly applied to the winch capstan, to sustain the tension of the load securing member, in the event that changing load conditions should tend to slacken the securing member.

The stiffness of the spring is such that as much as about six hundred pounds feet of torque can be applied, using a three foot tommy bar, moving through approximately one half turn (about 180 degrees).

To unload the winch, it is first necessary to unload the spring, by entering the tommy bar into the spring end cup; disengaging the spring torque arm from its stop on the torque bracket, and releasing the tensioned spring, under control. The spring can then be removed from the capstan, and the capstan accessed to unload the winch ratchet, which can then be released in the usual fashion, and the winch fully unloaded, to enable releasing of the load strap or other load restraint member.

In another, attachable embodiment, a strong coil spring also having an in-board extended torque arm fitted with an end cup to receive a tommy bar in inserted, torque transfer relation, has the outboard end of the spring extending axially in engaged relation with a rotator cuff connected in driving relation to the winch drum by means of a pawl and ratchet wheel, wherein the pawl is pivotally mounted upon the rotor cuff.

A torque bracket is provided, as disclosed above, that bolts on to the adjacent end plate of the winch frame, the bracket having a series of stops against which the extended torque arm of the spring can be selectively engaged.

A ratchet wheel and ratchet pawl portion that forms a part of the of the attached spring load tensioning kit enables selective coupling of the tensioning spring to the winch drum in torque-transfer relation therewith, to drive the drum in tension-maintaining relation with the hold-down member.

Stiff springs are used, such that for approximately one half turn of the spring, as an example, a torque of as much as up to about 600 pounds-feet may be generated.

In the event of load settlement, this extent of spring loading might typically impart about six to eight inches of tightening displacement to a load strap, while maintaining considerable tension upon that strap. The extent of winding displacement of the strap is a function of the number of underlying turns of the load strap, which determines the effective radius about which the strap is taken up by the action of the spring.

Other kit embodiments include the provision of a replacement winch drum of extended length, the extended end of which protrudes beyond the winch frame, enabling the mounting of the spring and other elements of the kit directly upon the drum extension.

The coil spring of the kit may have its inboard end provided with a hook portion, to engage the adjacent edge of the adjoining frame side plate.

The use of a flat section coil spring (clock) embodiment also is contemplated and shown.

The present invention thus provides a method of tensioning a load restraining, manually operated winch having a flexible hold-down member wound in tensioned relation upon a rotatable drum, including the steps of providing a removable driving spring, and connecting it in loading relation with the drum, tensioning the spring, and restraining the spring against reverse over-run, whereby, upon reduction of tension in the hold-down member due to a change in load conditions, the drum is driven by the driving spring to at least partially maintain tension in the hold-down member, to maintain restraint upon the load by the hold-down member.

All but one of the present embodiments permits a modified loading method, wherein the pre-load applied to the spring may be utilized to boost the loading of the load strap to a tension beyond that which could otherwise be achieved.

Thus, with the load strap tensioned by normal, manual operation of the winch, the spring is pre-loaded, and the operator then re-applies his/her tommy bar to manually load the capstan. This means that the spring torque is added to the manual effort of the operator, thus correspondingly boosting the tension loading applied to the load strap.

The spring may then be re-tensioned, to provide its back-up torque to the winch.

### BRIEF DESCRIPTION OF THE SEVERAL VIEWS OF THE DRAWINGS

Certain embodiments of the invention are described by way of illustration, without limitation thereto other than as set forth in the accompanying claims, reference being made to the accompanying drawings, wherein:

FIG. 1 is an end perspective view showing a portion of a standard type of truck winch, together with the elements of one embodiment of the present invention in exploded, disassembled relation;

FIG. 2 is an end view of a rotator cuff portion of the safety adaptation kit, viewed from the inboard end;

FIG. 3 is a side view of the rotator cuff of FIG. 2

FIG. 4 is an end view in elevation of a removable hooked spring embodiment with extended torque arm and cup, with a torque bracket;

FIG. 5 is an end perspective view of a spring embodiment with extended torque arm, and an associated rotator cuff;

FIG. 6 is a side elevation of an assembled embodiment having an extended winch drum;

FIG. 7 is an exploded perspective of the elements of the FIG. 6 kit;

FIG. 8 is a view similar to FIG. 6 of a flat section coil spring embodiment; and,

FIG. 9 is a view similar to FIG. 7, of a simpler extended drum embodiment.

### DETAILED DESCRIPTION OF THE INVENTION

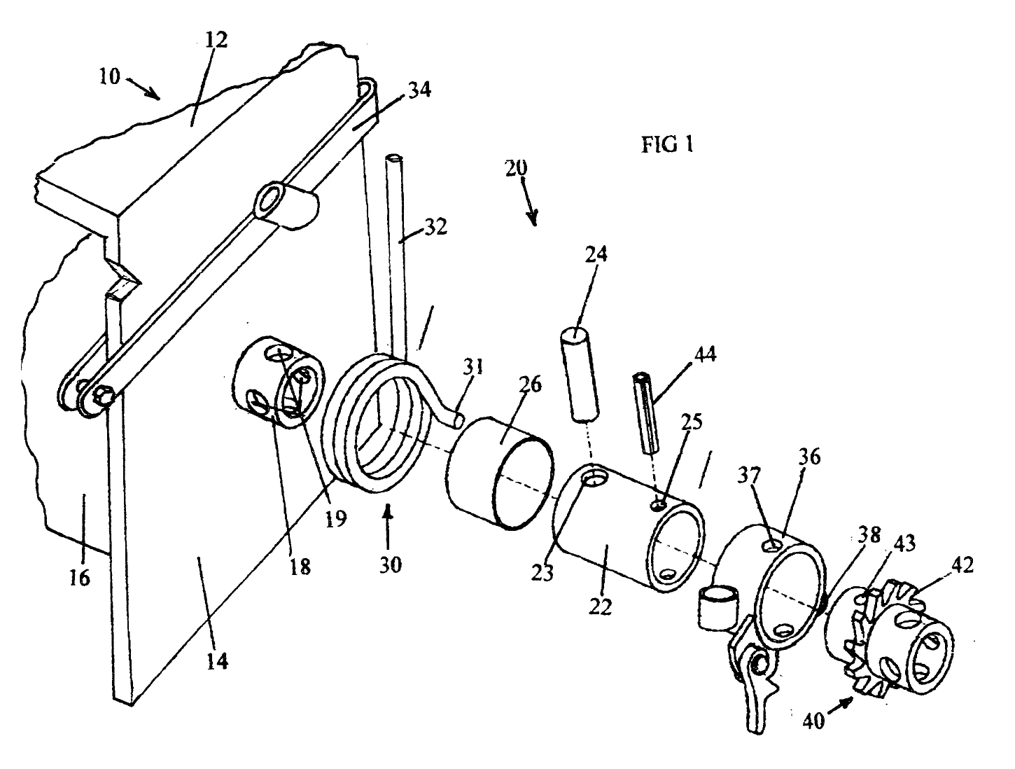

Referring to FIG. 1, a portion of a winch 10 is shown, having a top frame member 12, a frame end member 14, and a drum 16, with a capstan 18 projecting from the member 14, to which capstan 18 the safety adaptation kit 20 in accordance with the present invention is mounted. The capstan 18 has four bar apertures 19 that normally receive the tapered toe of a trucker's loading bar (not shown), known as a “tommy” bar.

The kit 20 has a mounting barrel 22 with a first diametrical aperture 23 that matches a pair of the apertures 19 of the capstan 18. With the mounting barrel 22 positioned on the capstan 18, a cylindrical mounting pin 24 can be inserted through the respective aligned apertures 23, 19, 19, 23 of the barrel 22 and capstan 18, to securely mount the barrel 22 upon the capstan 18. The barrel 22 has a second diametrical aperture 25 at its outer end.

A pin retaining cylinder 26 is then slid over the barrel 22, to trap the mounting pin 24 in secured relation in the capstan 18 and barrel 22.

A torsion spring 30 is then slid over the barrel 22, and a protruding inboard end 32 of the spring 30 is secured to the winch end frame member 14 by way of a clamp 34, which is bolted about the spring end 32 and the frame member 14.

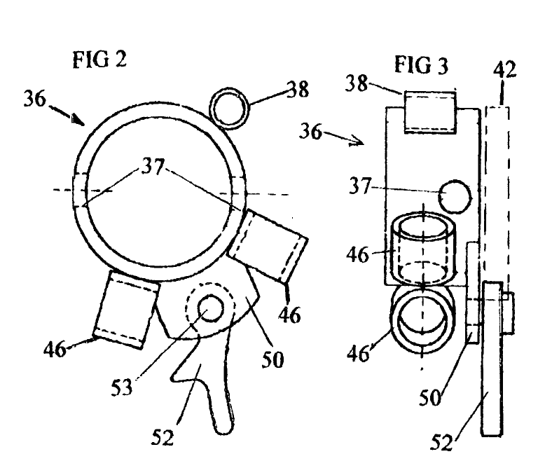

A rotator cuff 36 ( see also FIG. 2), is inserted over the barrel 22, being entered in supporting relation within the outer coil of spring 30, with an outer tang end portion 31 of the spring 30 being inserted into a bushing 38 that forms a part of the rotator cuff 36. The cuff 36 has a diametrical access aperture 37, through which a spring pin 44 can be passed for insertion into the aligned apertures of other component parts.

A capstan 40 with an integral ratchet wheel 42 is inserted into the outer end of the barrel 22, having a diametrical inner aperture 43 of capstan 40 aligned with aperture 25 of the barrel 22, and with a diametrical access aperture 37 of the rotator cuff 36.

A spring pin 44 is inserted through the aligned diametrical access aperture 37 of the cuff 36, into engaging relation with the apertures 25 , and 43 of the barrel 22 and capstan 40 respectively, which serves to secure the barrel 22 and capstan 40 in mutual rotational and torque transfer relation, independently of rotator cuff 36.

The spring pin 44 has a length that is less than the inner diameter of the cuff 36, being located so as not to make contact with the cuff 36 or impede the free rotation of cuff 36 upon the barrel 22.

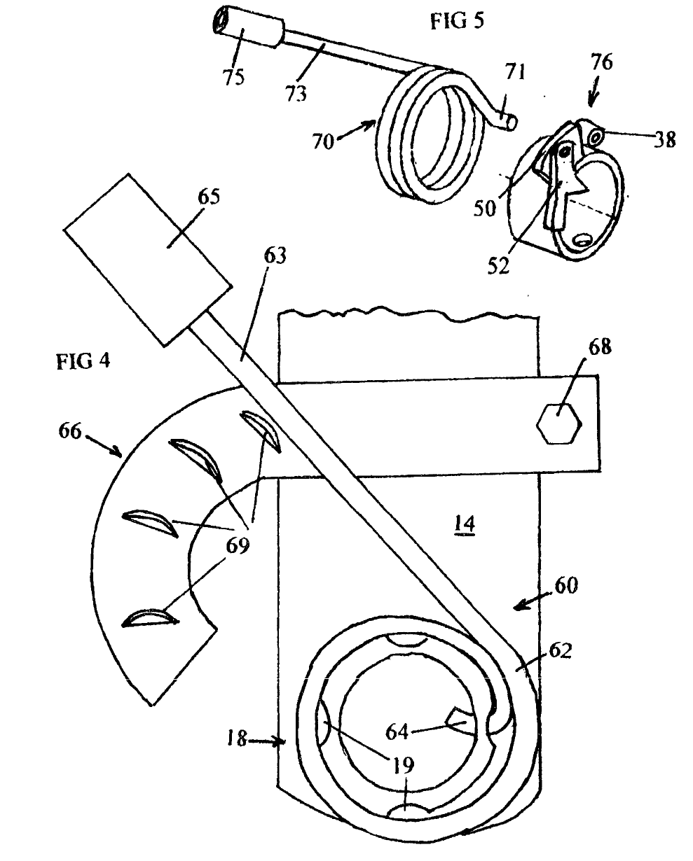

Referring more particularly to FIGS. 2 and 3, the rotator cuff 36, with its diametrical apertures 37 which permit passage therethrough of the spring pin 44, and its cylindrical bushing 38 which receives the spring tang end 31, the cuff 36 also has a pair of bar bushings 46 secured thereto, being spaced about 80 degrees apart from each other, on the periphery of the rotator cuff 36. These bar bushings 46 are sized and located to receive the end of a tommy bar in securely inserted relation therein, for applying load to, and removing load from the spring 30, by rotation of the rotator cuff 36, which is rotationally supported upon the barrel 22..

The rotator cuff 36 has a flange 50 from which a toothed pawl 52 is pivotally suspended at 53.

When the kit 20 is assembled upon a capstan 18, the pawl 52 overhangs the ratchet wheel 42, (shown in phantom, in FIG. 3).

Upon inserting a tommy bar into a bar bushing 46, and levering upwardly, the resulting rotation of the rotator cuff 36 (in a clockwise direction when viewed from an outboard position, as in FIG. 1), causes the pawl 52 to pivot inwardly into engaging relation with the teeth of the ratchet wheel 42. Meanwhile, the tang 31 of the spring 30 is also correspondingly displaced by the rotation of the cuff 36 so as to tension the spring 30.

In operation, before tensioning the spring 30, the load strap (not shown) which has one end secured to the drum 16, is wound onto the drum 16 by anti-clockwise rotation of the capstan 40, to take up the slack.

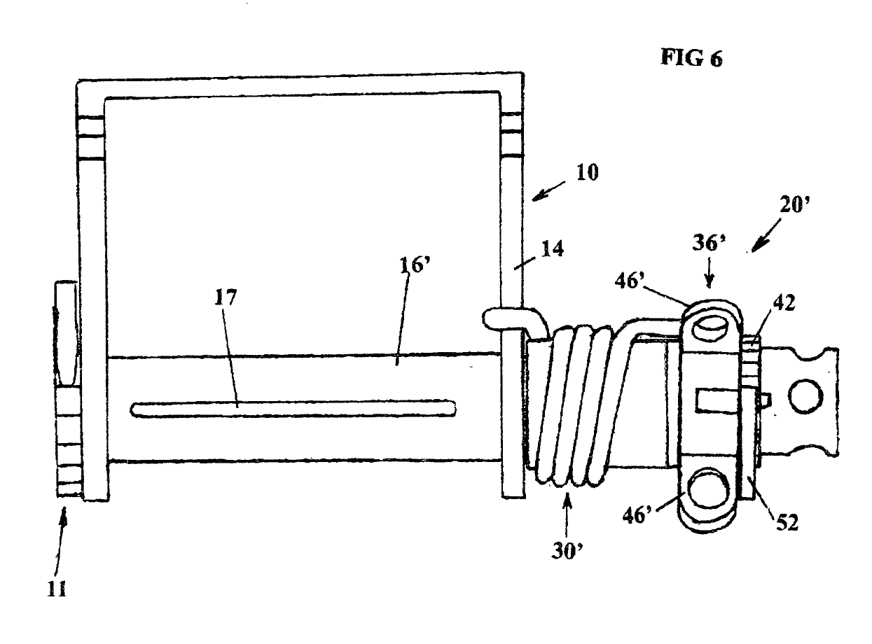

By inserting the tommy bar into the capstan 40 and applying his weight to the end of a three-foot long tommy bar, a two hundred pound driver can then apply about 600 foot pounds of torque to the capstan 40, thus correspondingly tensioning the load strap. The original ratchet 11 of the winch 10 (as seen in FIG. 6) retains this loading, and prevents over-running of the drum 16 by the tensioned load strap.

Then, inserting the tommy bar into a bar bushing 46 of the cuff 36, the trucker can raise the end of the tommy bar, to tension the spring 30 while bringing the pawl 52 into engagement with the ratchet wheel 42.

By applying, as a for-instance, a one hundred pound effort upwardly on the tommy bar, a torque of about three hundred pounds feet is applied to the spring, and transferred to the ratchet wheel through the pawl 52

If left in this initial spring-loaded condition, then in the event of reduction in tension in the load belt due to load settlement or shifting, to a value less than that applied by the spring, the spring-loaded ratchet wheel will drive the drum 16, to take up at least part of the changed belt condition.

However, the initial spring-loaded condition can be used to increase the strap load, beyond that which the driver is normally capable of applying. With the spring tensioned to say, three hundred foot pounds of torque, and with the driver applying a downward load with the tommy bar of his usual six hundred pounds feet of torque, a total of nine hundred pounds feet of torque can be applied to the belt. Upon doing this, the spring tension can then be re-applied by upward application of torque to the rotator cuff 36. This then leaves that winch with a significantly increased initial strap loading, while also permitting the loaded spring to provide further insurance against subsequent loss of tension in the load strap.

Referring to FIG. 4, a hooked spring embodiment 60 has a spring 62 with a hooked end 64 for directly engaging one of the holes 19 of the winch capstan 18. The other end of spring 62 consists of an extended torque arm 63 having a torque cup 65 at its end to receive the end of a tommy bar (not shown) in inserted, torque-transfer relation therein. A torque bracket 66 is bolted at 68 to the frame end member 14. The bracket 66 has a series (four being illustrated) of axially projecting stop members 69, to engage and retain the spring torque arm 63, when inserted into engagement with a stop member 69.

The spring 60 is initially removed from the winch until the winch has been operated to take up any slack in the load belt, and to apply the usual extent of loading by way of the tommy bar. When this has been done, the spring 60 is dropped over the capstan 18, and the hooked end 64 engaged with a suitably located hole 19 of the capstan 18 as to position the spring torque cup 65 in an elevated position. The tommy bar is then entered into the cup 65, and the cup 65 is levered downwardly to a desired location, and the spring torque arm 63 is positioned in retained relation behind a selected one of the stop members 69 of the torque bracket 66.

In an alternative embodiment combing the elements of FIG. 5, in conjunction with some of those of FIGS. 1 and 4, a winch 10, having a torque bracket 66 (of FIG. 4) bolted to the end plate 14 thereof, has a spring 70 (of FIG. 5) mounted upon cylinder 26 (of FIG. 1). The spring 70 has a torque arm 73 with a torque cup 75. An axially extending tang end portion 71 of the spring 70 is engaged with a bushing 38 of a rotor cuff 76 (of FIG. 5). The rotor cuff 76 has a flange 50 located so that the pawl 52 normally hangs in engaging relation with the ratchet wheel 42 of the capstan 40. The elements 22 and 26 from FIG. 1 complete the assembly.

In use, the pawl 52 is engaged with the ratchet wheel 42, so that the rotor cuff 76 is immobilized against anti-clockwise rotation, as viewed in FIG. 5. Spring tension is applied by engaging the torque cup 75 of the spring 70 with the tommy bar and levering downwardly, to bring the spring torque arm 73 into engagement behind one of the stop members 69 of the torque bracket 66. The torque load thus applied to the spring 70 is transferred by the pawl 52 to the winch 10.

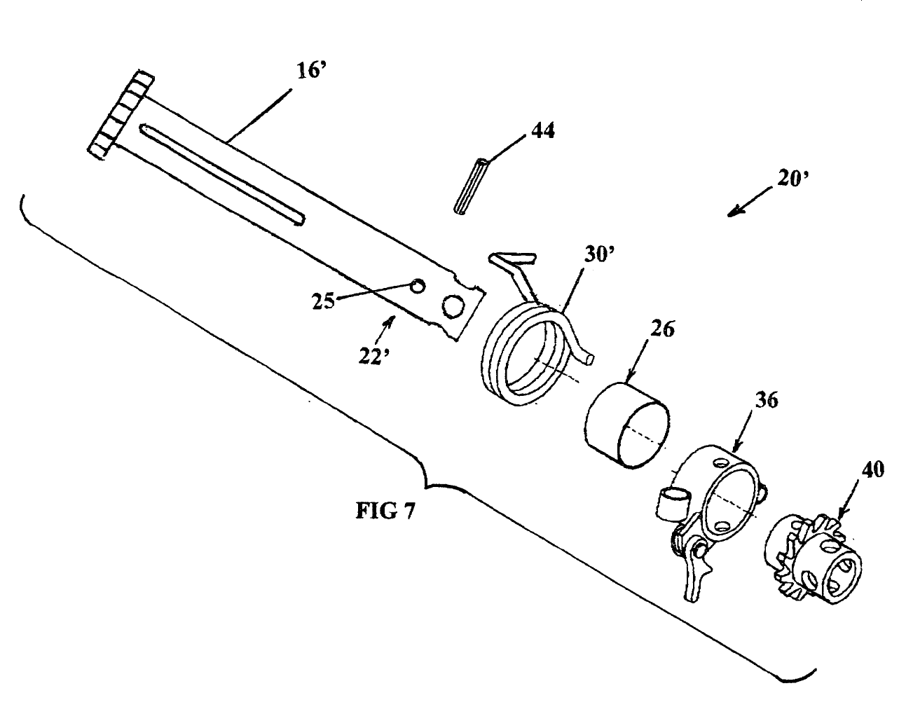

Turning to FIGS. 6 and 7, a winch 10 has an extended drum 16′ which extends outside the frame end member 14, and upon which the members of the kit 20′ are mounted.

The drum 16′ has a slot 17 through which a load restraint strap (not shown) may be threaded and anchored

In FIG. 6, the rotator cuff 36′ is shown as having a pair of apertured torque brackets 46′ to receive the tommy bar in entered torque transfer relation, in place of the bar bushings 46 of FIGS. 1, 2, 3 and 7.

Comparing the kit 20′ with that of FIGS. 1, 2 and 3 the extended drum portion 22′ (see FIG. 7) provides the function of the mounting barrel 22 of FIG. 1; also, the spring 30′ of FIGS. 6 and 7 has the inboard end formed in a reversed bend, to engage the front edge of the frame end member 14 and anchor the spring 30′, thus enabling the application of clockwise tensioning forces to the spring, with associated counterclockwise forces transferred to the drum 16′ by way of the pawl 42 and ratchet wheel 52..

The remaining elements 24, 26, and 40 are substantially the same as, and mostly provide the same functions as the corresponding elements of FIG. 1.

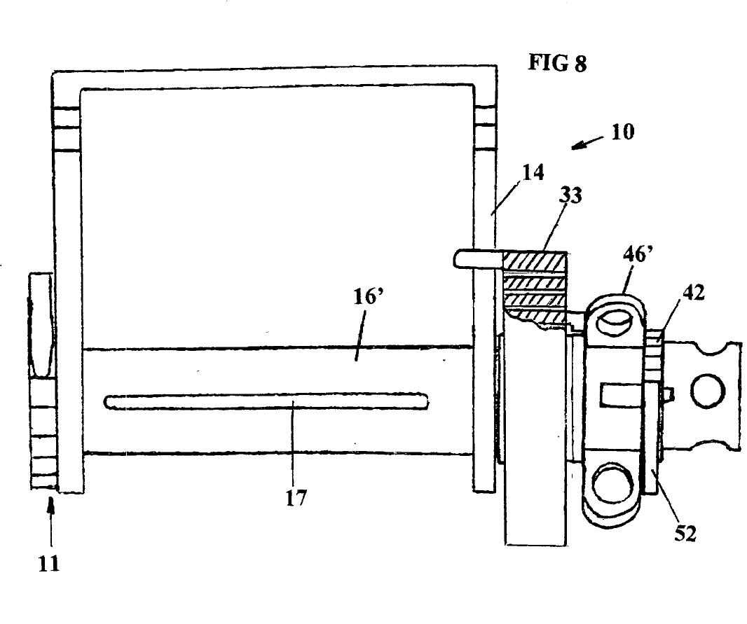

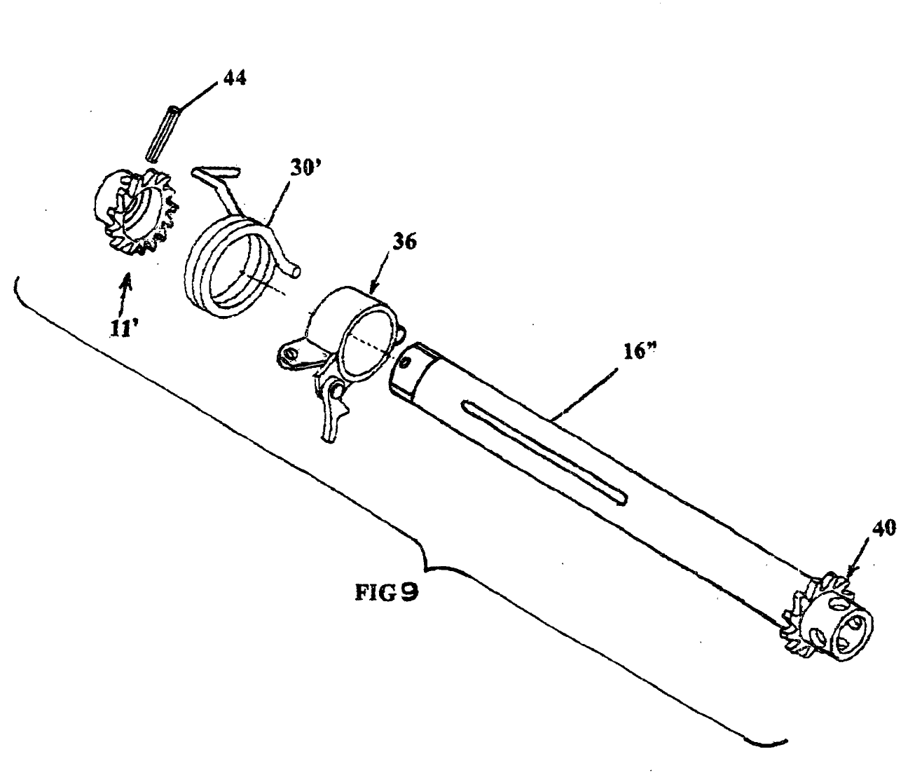

Referring to FIG. 8, a flat coiled (clockwork-style) spring 33 is substituted for the coil spring 30 or 30′; and the rotator cuff 36′ has a pair of apertured torque brackets 46′ through which the tommy bar may be inserted, as compared with the bar bushings 46 of FIGS. 1, 2 and 7.

Adoption of the clock spring 33 enables the drum 16′ to be made somewhat shorter, and reduces the overall length of the winch installation.

In FIG. 9 the extended drum kit embodiment 20″ has an extended drum 16″ which, when installed, extends outside the frame end member 14, and upon the extended portion of which the members of the kit 20′ are mounted. However, the supplementary capstan/ratchet wheel 40 is secured to the outboard end of the extended drum 16″, while the “original” ratchet wheel 11′ is removably attached to the the opposite end of the drum 16″. This attachment of ratchet wheel 11′ is illustrated both by way of threaded attachment, and by way of a spring pin 44. While either or both may be used, attachment solely by way of the inserted spring pin 44 is preferred, for speed and ease of assembly.

The kit 20″ is assembled to a winch frame, the rotator cuff 36 being slid onto the drum 16″, followed by the spring 30′. The drum 16″ is then passed (leftwardly) through the winch frame, with the hooked inboard end of spring 30′ engaged with the edge of the frame end member 14 ( see FIG. 8).

The ratchet 11′ is then secured to the end of drum 16′, as discussed above, thus locking the whole assembly in place. It will be observed that the pin 24 and pin retaining cylinder 26 shown in other embodiments, are now dispensed with.

The flat spring 33 of FIG. 8 may be incorporated in an embodiment like that of FIG. 9.

1. A winch for securing loads to a flat-bed by way of a tensioned flexible load securing member, the winch having a first capstan for the prior application of a first torquing force to the winch to tension said member, first ratchet means to prevent overhauling of said winch by said load securing member, in combination with a powerful spring attached to the capstan, wherein the application of a second torquing force to the spring in tensioning relation therewith substantially equivalent to one half turn of the capstan imparts sustaining torque to the capstan independently of said first torquing force applied in tensioning said member, said sustaining torque being in the range of 25% to 100% of said prior applied torquing force.

2. The winch as set forth in claim 1, wherein said spring has a hooked end portion, and is hooked directly onto said capstan, said spring having an extended torque arm, with load means secured thereto to enable connection of a loading bar to said spring, in torque transfer relation.

3. The winch as set forth in claim 2, having a torque bracket secured to a frame portion of said winch, wherein said spring extended torque arm is selectively attachable to said torque bracket.

4. The winch as set forth in claim 1, said combination including a second capstan with a ratchet wheel secured to said first capstan; and ratchet pawl means connecting said spring to said ratchet wheel, in use to transfer torque loading applied to said spring to said first capstan.

5. The winch as set forth in claim 1, including a mounting barrel; removable pin means securing said mounting barrel to said first capstan; rotator means rotatably mounted about said barrel, having said spring attached to said rotator means, and ratchet means selectively connecting said rotator means with said first capstan in torque transfer relation between said spring and said winch.

6. The winch as set forth in claim 5, including a retaining cylinder slidably mounted on said barrel in securing relation with said removable pin means.

7. The winch as set forth in claim 1, including bracket means removably attached to a frame portion of said winch, said bracket means having said spring in adjustably secured relation therewith.

8. The winch as set forth in claim 7, said bracket means including a bushing to receive an end of said spring in inserted, secured relation therein.

9. The winch as set forth in claim 7, said bracket means having a plurality of stop means thereon in mutually spaced relation, to permit selective connection of said spring in torque transfer relation with said bracket.

10. The winch as set forth in claim 1, having a drum portion of extended length projecting outside a frame portion of said winch, said projecting drum portion having said spring mounted thereon; second ratchet means selectively connecting said spring in torque transfer relation with said drum; and rotator means connected with said spring for tensioning said spring by torque applying loading displacement of the rotator means in a direction opposed to said first torquing force.

11. The winch as set forth in claim 1, wherein said spring is selected from the group consisting of coil and flat springs.

12. The winch as set forth in claim 10, wherein said second ratchet means is removably secured to said projecting drum portion.

13. The winch as set forth in claim 10, wherein said spring is located adjacent a proximal end of said drum, and a ratchet wheel portion of said first ratchet means is removably secured to a distal end of said drum.

14. The method of operating a winch in securing a load, said winch having a rotatable first capstan for the application of torsional energy in tensioning relation with a flexible load securing member, including the steps of applying a first rotation to said capstan to tension said securing member to a first extent; providing a powerful spring; connecting said spring in torque transfer relation with said capstan; and tensioning said spring by a portion of one rotation to apply a sustaining torque to said capstan, whereby, upon diminishment of said tension in said securing member to a value below said sustaining torque, said spring will operate to sustain said securing member in a tensioned condition.

15. The method as set forth in claim 14, wherein said spring is connected with said capstan subsequent to the application of said first rotation; said spring being tensioned by the application of torque in a direction of rotation corresponding with said first rotation.

16. The method as set forth in claim 14, wherein said spring is connected with said capstan prior to the application of said first rotation; said spring being tensioned by the application of torque in a direction of rotation opposite to said first rotation.
